(19) United States
(12) Patent Application Publication
(10) Pub. No.: US 2012/0191474 A1
(43) Pub. Date: Jul. 26, 2012

(54) SYSTEM AND METHOD FOR CENTRALIZED MANAGEMENT AND MONITORING OF HEALTHCARE SERVICES

(76) Inventor: Richard Postrel, Miami Beach, FL (US)

(21) Appl. No.: 13/245,986

(22) Filed: Sep. 27, 2011

Related U.S. Application Data
(63) Continuation of application No. 13/038,610, filed on Mar. 2, 2011, now abandoned.
Application No. 13/038,610 is a continuation of application No. 11/869,734, filed on Oct. 9, 2007, now abandoned.
Application No. 11/869,734 is a continuation-in-part of application No. 11/144,377, filed on Jun. 2, 2005, now abandoned.
(60) Provisional application No. 60/576,634, filed on Jun. 2, 2004.

(51) Int. Cl. G06Q 50/24

(52) U.S. Cl. 705/3

(57) ABSTRACT

A method of operating a centralized healthcare management system that includes a data translation map database and a central interpolation server computer interconnected to a computer network. The central server references a data translation map database for a desired translation map that enables the central interpolation server to translate data records from a source format to a destination format.

### CROSS-REFERENCE TO RELATED APPLICATIONS

This application is a continuation application of application Ser. No. 13/038,610 filed Mar. 2, 2011, which is a continuation application of application Ser. No. 11/869,734 filed Oct. 9, 2007, which is a continuation-in-part application of application Ser. No. 11/144,377 filed Jun. 2, 2005, which claims priority from provisional application 60/576,634, filed Jun. 2, 2004.

### FIELD OF THE INVENTION

The present invention relates to the provision of medical and related management and monitoring services, and in particular to a method and system using a central server in conjunction with locally distributed legacy servers, systems, devices and databases for managing and monitoring healthcare services, payments, costs, risks, quality control, and performance measurement.

### DESCRIPTION OF THE RELATED ART

The healthcare industry today is a complicated and fragmented system. People at different times require the services of various types of healthcare providers, such as doctors, home care nurses, dentists, surgeons, therapists such as physical therapists and the like. People will utilize these services as needed or on an emergency basis, or often on recommendations of others. As a result, people will tend to use such healthcare providers that have no relationship with one another, which results in fragmented healthcare management. For example, a person may have medical records on file with a general practitioner doctor, a number of specialists, their dentist, etc. This can lead to redundancy of paperwork, increased human error, which in turn can lead to mistakes in providing care, for example when one healthcare service provider does not have a complete record of a patient's medical history and makes an incorrect diagnosis or recommendation as a result. Mistakes can also occur when a patient visits a new doctor and provides erroneous background information. Expenses are driven upwards when healthcare service providers try to obtain prior records such as x-rays, etc. in order to dispense treatment. It is estimated that 20% of diagnostics are redundant since the required information is not in the right place at the right time. These issues also lead to delay in obtaining treatment. As a result, many people will not seek appropriate medical treatment (including preventative care and maintenance) because it is too inconvenient, cumbersome, confusing, and time-consuming. It is critical to provide the required information at the point-of-care, such as in emergency room care with a patient having no medical records immediately available or in ambulatory care.

The patient-specific issues mentioned above are also problematic from the viewpoint of the healthcare service provider. In addition, the healthcare service provider is usually paid by a health insurance company or other third party (such as a credit union), which adds many more problems such as inordinate delays in getting paid, increased paperwork, and even nonpayments in some cases. This increases the cost of providing services and takes away the providers' time that could otherwise be spent tending to their patients.

Healthcare insurers also face problems such as insurance fraud (for example where claims are made for services not rendered, excessive testing, improper prescriptions, etc.) and the increased cost of processing the insurance claims from the healthcare service providers as well as patients.

Healthcare service centers such as hospitals, as well as their patients, also face similar problems. Persons desiring to obtain medical care, for example in an emergency situation, often encounter long delays in getting appropriate treatment. Delays may be attributed to several factors. One factor is the requirement for a patient to fill out forms at the emergency room intake, including personal information (e.g. name, address, telephone number), past medical history, and insurance information. This type of information is static since it generally does not change based on the emergency at hand. Other information that must be provided is situation-specific, such as the symptoms encountered by the patient at the time of the particular visit to an emergency room or other healthcare provider. Delays are further encountered when the emergency room personnel must process the information provided by the patient, such as when they must verify the validity of the insurance information given, or if no information is provided. Delays such as these can have significant consequences in situations where care must be immediately provided. Even in those non-emergency situations, long delays in obtaining appropriate care is undesirable.

It is therefore desired to provide a healthcare management and monitoring service that interoperates with subscribers to the service, who may be patients, healthcare providers, healthcare institutions, governmental agencies, pharmacies, pharmaceutical companies, insurance companies, etc. in order to promote a patient's well-being, reduce their anxiety, and generally to overcome these problems of the prior art. In the case of healthcare providers and institutions it is desired to provide such a system in order to reduce the risks and liabilities associated with their practice.

It is a further object of the invention to provide such a healthcare management and monitoring service that can manage all of the transactions between these parties to reduce costs, increase speed of payment, and reduce if not eliminate payment on fraudulent claims and unnecessary procedures.

It is a further object of the invention to provide such a centralized healthcare management and monitoring service that reduces medical history management burdens by providing access to local distributed repositories of patients' medical histories that is secure, easily accessed by authorized parties, and easily modified or created as diagnoses are made and treatments are rendered, and in particular to provide differing levels of access and security through means such as PINs, biometric identifiers, etc., or combinations of various security options as desired.

It is a further object of the invention to provide such a healthcare management and monitoring service that utilizes a portable token such as a healthcare card for identifying carriers thereof as subscribers to the system, enabling for example the patient/subscribers to receive priority healthcare in conjunction with the system.

It is a further object of the present invention to utilize the aforementioned healthcare card to quickly access the patient's medical records from the repository, view the medical records, and modify the medical records as authorized by the system.

It is a further object of the invention to provide a system that enables aggregation or batching of products or services in the healthcare field and thus provide efficient and cost-effective treatment of patients.

It is a further object of the invention to provide a centralized healthcare management and monitoring service that provides monitoring of procedures, costs, payments, etc. to ensure compliance with a variety of rules, regulations and medical standards.

It is a further object of the invention to provide a centralized healthcare management and monitoring service that provides incentive to participants in the form of health performance and a dynamic health score (similar to a credit score), which for example may be in the form of health performance points that may be earned for participating in health-related activities and/or for maintaining a healthy lifestyle, and which allows a participant to accumulate such health points and redeem them towards a variety of awards such as reduced insurance premiums, and which provides for a reduction in the dynamic health score based on negative health activities, thereby providing a health performance measurement tool.

It is a further object of the invention to reduce insurance costs and reduce risks by implementing proactive procedures and preventative and maintenance care activities.

### SUMMARY OF THE INVENTION

The present invention particularly addresses the problems described above with respect to interchange of data such as medical records between and amongst the multiplicity of legacy data repositories having disparate data formats. Rather than attempting to collate all data that is already existing in various databases across the nation (and even the world) into a single repository, the present invention allows existing data to continue to be locally distributed and provides for an data interchange solution featuring a central server system as described herein. This healthcare utility uses existing systems, databases, architectures, platforms and equipment managed through one or more central server systems.

The preset invention allows requesting parties such as doctors, patients, hospital administrators etc. to use a data access terminal to request data records such as medical records and the like, and have a central server system search for, retrieve, and translate the requested data from the legacy servers and databases into the format required or readable by the requesting party. The reverse operations are also provided wherein a party may modify or add to the existing database via the central server system. This invention operates in closed as well as open environments, and will enable a closed environment to be opened up to enable robust data access.

The present invention is thus a method of operating a centralized healthcare management system such as on a state-based level that includes a data translation map database and a central interpolation server computer interconnected to a computer network. The central server receives, via the network, an initiating request from a requesting terminal for a data record to be retrieved that relates to or satisfies a specified condition. The central server will send, via the network, a data record request to a source database and then receive a data record from the source database, with the data record being in a source format. The central interpolation server references a data translation map database for a desired translation map, with the data translation map enabling the central interpolation server to translate data records from a source format to a destination format. The central interpolation server translates, in accordance with the selected data translation map, the received data record from the source format into a destination format suitable for transmission to the requesting terminal. A standard template may be used for increased readability if desired. The central server then transmits the data records in the destination format to the requesting terminal via the network. In this manner, the security of existing data source databases is not compromised by using a central server since no data is stored in the central location (unless opted into by a subscriber for service on an isolated designated server).

The initiating request from the requesting terminal may comprise an identification of the source database to which to send the data record request. Alternatively, the data record request may be sent to a plurality of source databases interconnected to the centralized healthcare management system via the network, each of which may or may not comprise data records that satisfy the specified condition. Further alternatively, the central interpolation server may execute a search to determine an identification of at least one source database that has a data record that satisfies the specified condition. This search may encompass searching a library of headers that are used for data translation purposes.

The condition specified in the data request may for example be an identification of a specific data record requested for a specific subscriber or non-subscriber, or it may be a request for all data records available for a specific subscriber, or it may be an identification of a specific data record requested for a group of subscribers meeting a predefined criteria, or it may be an identification of all data records available for a group of subscribers meeting a predefined criteria.

By way of example, the data translation map database may include a plurality of headers, with each header being associated with a source database or a destination database. Each header may have a number of different fields and a number of associated tags, wherein each tag is assigned to a field, and wherein tags from a header associated with a first database may be mapped with tags from a header associated with a second database such that a field in a data record from the first database may be matched to a field in a data record from the second database in accordance with the matching of the respective tags, regardless of the location of each field in the respective data record. The translation map may be generated in real-time by retrieving a header associated with the source database and a header associated with the requesting terminal.

In addition, the present invention supports the ability to optionally modify data in the source database by first modifying the data record at the requesting terminal to create a modified data record, then sending, via the network, the modified data record to the central interpolation server. The central interpolation server receives the modified data record in the destination format from the requesting terminal, and then translates in accordance with the data translation map the received modified data record from the destination format into the source format. The central server then transmits the modified data record in the source format to the source database via the network.

In one preferred embodiment, no data records are maintained at the central interpolation server, so that all data record requests are made to external source databases. In the alternative, subscribers may elect to have data records stored at an isolated data repository available to the centralized healthcare management system for subsequent use.

In the event that data records reside in a database that is part of a state-based system different from the requesting party, then the state-based central healthcare server in the requesting state will request the desired records via the state-based central healthcare server in the other state (where the source database resides). As a further embodiment, an enterprise server is implemented to manage data retrieval and translation between entities in states that do not subscribe to the system and those who do (i.e. affiliated and unaffiliated entities). This allows entities from unaffiliated states to register with the enterprise server so the appropriate central server may route data record requests to these unaffiliated entities without requiring them to be affiliated with a state-based central server system.

The present invention is configured to enable states to set up their own system that may evolve into a federated system, which will be the open framework for a national healthcare solution.

### BRIEF DESCRIPTION OF THE DRAWING

FIG. 1 is a top level block diagram of the national healthcare management system of the preferred embodiment of the present invention.

FIG. 1a is a more detailed block diagram of the national healthcare management system of FIG. 1.

FIG. 2 is an block diagram of the central healthcare management system of FIG. 1.

FIG. 3 is a detailed diagram of the translation functionality of the present invention.

FIG. 4 is an illustration of a portable terminal used with the present invention.

FIG. 5 is a block diagram of the functionality and circuitry of the terminal of FIG. 4.

FIG. 6 is a flowchart of the data request and translation functionality of the present invention.

FIG. 7 is a flowchart of the data modification and translation functionality of the present invention.

### DETAILED DESCRIPTION OF THE PREFERRED EMBODIMENT

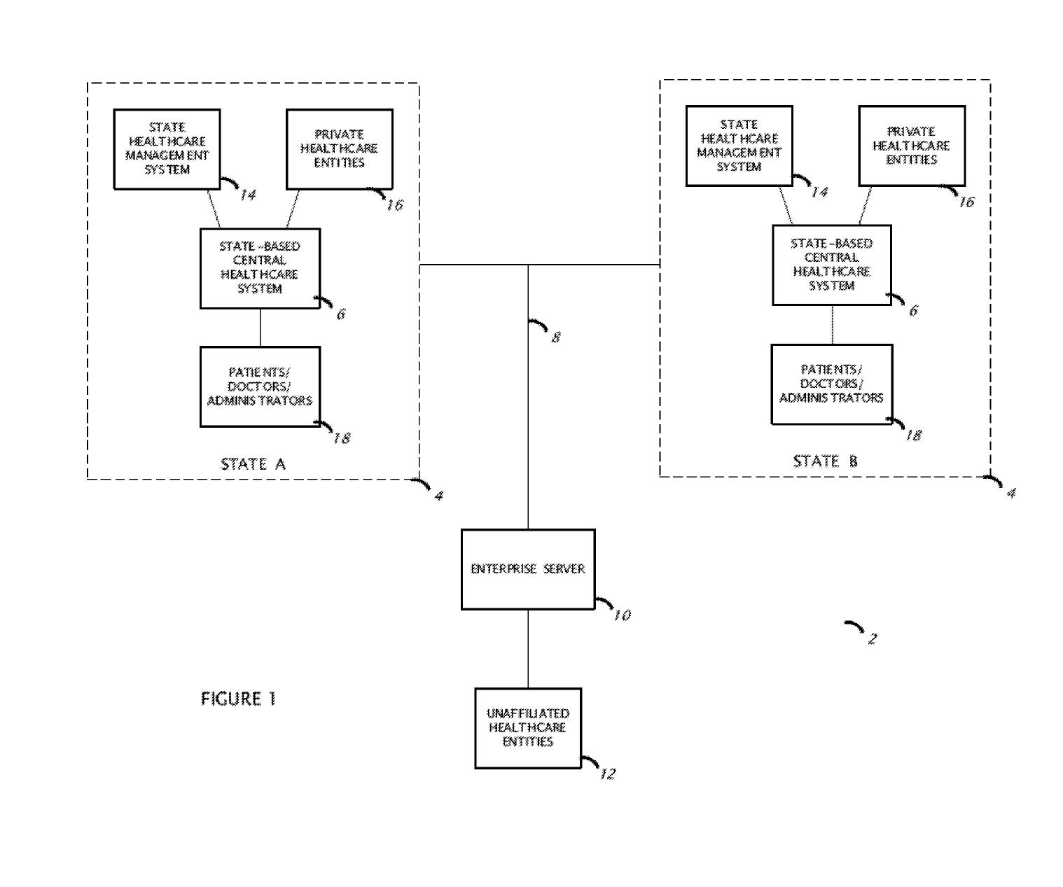

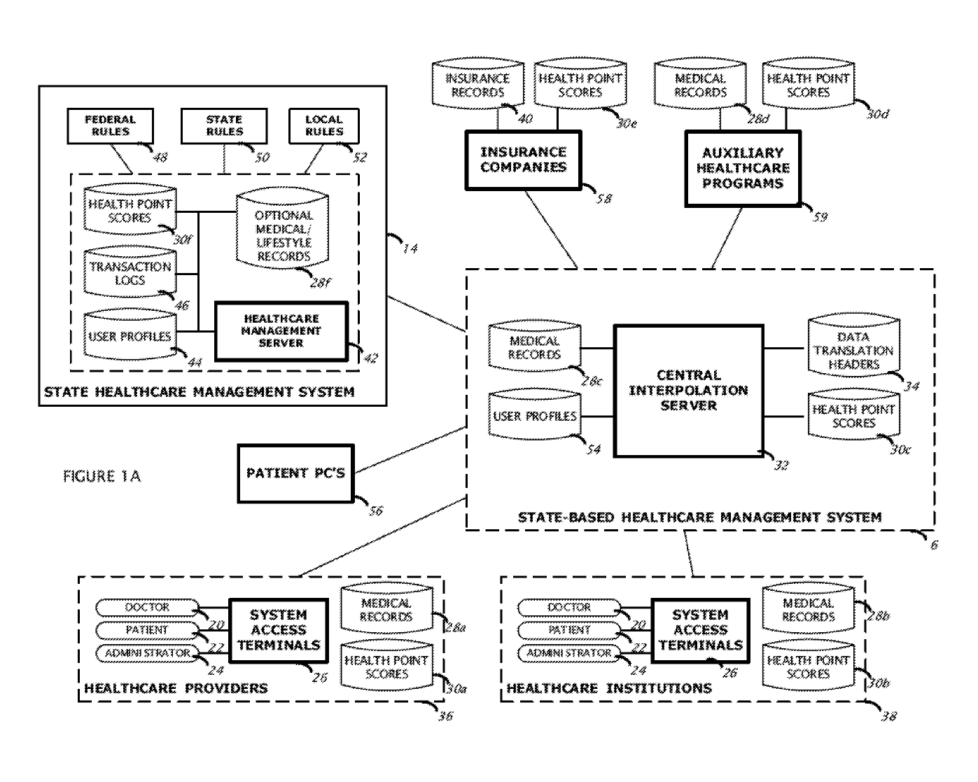

As shown in FIG. 1, a national system 2 has two states (State A and State B) operating a state-based central healthcare system 6, and each state's system 6 may interconnect via a wide area network 8 with each other. Although only two exemplary states State A and State B are shown in FIG. 1, this may of course be extended to a multiplicity of participating states. In addition, an enterprise server 10 interconnects with the network 8 to enable any of the state systems 6 access thereto. The enterprise server 10 will allow access to those data sources that reside with unaffiliated healthcare entities 12 that have not subscribed to a given state system, which may occur if the state in which that unaffiliated party resides is not yet a member or subscriber of the overall system. As will be further described below, each state-based central healthcare system 6 will interoperate with a pre-existing state healthcare management system 14, a plurality of private healthcare providers 16, and a plurality of subscribing entities 18 such as hospitals, doctors, administrators, health clubs, as well as the patients themselves.

The system 4 of each state will now be described in further detail. As shown in FIG. 1A, the central component of the state-based healthcare system is a central healthcare management system 6, which is the core of the preferred embodiment of the invention. Also shown are subscribers 18 (see FIG. 1), which is further detailed in FIG. 1A as a plurality of healthcare providers 36 (such as doctors, therapists, dentists, as well as non-licensed caregivers), a plurality of healthcare institutions 38 (such as hospitals), a plurality of auxiliary healthcare programs 59 (such as health clubs and gyms), and a plurality of health insurance companies 58. All of these entities interconnect with the central healthcare management system 6 via corresponding computers, systems and devices over a wide area computer network (not shown). The network employed may be a general purpose wide area network such as the Internet, which is advantageous due to its ubiquity. In addition, dedicated networks may be employed or connected as may be desired. A further optional embodiment implements a card processing network or the like as further described below.

The present invention operates on the premise that medical records and other patient information should normally be kept in source databases, such as those operated by the various healthcare providers 36 and healthcare institutions 38 that the patient may utilize. This is a practical aspect of the invention that will allow it to piggyback on top of the many medical records databases that already exist, for example in the patient's primary care doctor's office, a local hospital, etc. By enabling use of existing medical records databases, managed by the central interpolation server 32 of the central healthcare management system 6, there is no need to reconstruct the nation's entire medical system from the ground up.

Thus, medical records of a particular patient 22 may be kept in one or more of the following: medical records database 28a of a healthcare provider (e.g. a local doctor), medical records database 28b of a healthcare institution 38 (such as a hospital), and/or medical records database 28d of an auxiliary healthcare program 59 (such as a health club). In addition, as further explained herein, a patient 22 or other subscriber may elect (on an opt-in basis) to have certain or all of his or her medical records to be stored in a single location such as optional state-based medical records database 28f or central-based medical records database 28c.

Likewise, as further explained herein, a patient may have various health point accounts, which is a new feature of this invention, stored as a dynamic health score in any one or more of health point account database 30a of a healthcare provider 36, health point account database 30b of a healthcare institution 38, health point account database 30e of an insurance company 58, and/or health point account database 30d of an auxiliary healthcare program 59. In addition, as further explained herein, a patient 22 or other subscriber may elect to have certain or all of his or her dynamic health scores or health point accounts to be stored in a single location such as optional state-based health point account database 30f or central-based health point account database 30c. Various accounts may be merged to establish a healthcare quotient.

The state healthcare management systems may each be managed by a participating state entity, and would include a healthcare management server 42 that has access to pre-existing databases of federal compliance rules 48, state compliance rules 50, and/or local compliance rules 52. In addition, the state healthcare management server 42 will have local databases configured in accordance with this invention including user profiles 44, transaction logs 46, health point accounts 30f, and (optionally) medical records 28f. By keeping this information separate, each state may manage its own healthcare records and compliance rules system(s) independently from the central system 6, yet advantageously interact with other subscribers to the system.

The present invention allows legacy computer systems that contain relevant information to interact with other legacy systems to provide and modify data, execute transactions such as payments and the like, notwithstanding the fact that these legacy systems were not designed or configured to interact with each other. That is, the present invention provides a seamless process for translating or mapping data from one legacy system into a format required or expected by another legacy system, and vice versa, so that the otherwise incompatible systems may easily interact. This invention also allows interoperability with existing databases in order to collect and aggregate relevant data as desired.

The present invention addresses the logistical problems caused by attempting to interconnect many different systems to a central server where each system has been designed independently with no pre-existing standards for data processing implemented. This has heretofore been a major hurdle in attaining interoperability without redesigning and reconfiguring every such independent system. However, the present invention implements a header tagging system to map various data components to each other via the central interpolation server 32 so that data may be interchanged efficiently and easily, without errors due to translation problems. This will be explained in further detail below.

Thus, the central healthcare management system 6 is an intermediary between the subscribing parties described above and shown in FIG. 1A in accordance with the transaction being executed. For example, when a patient 22 requires emergency room treatment at a healthcare institution 38, the central healthcare management system 6 will be a liaison or intermediary between the patient 22 and the healthcare institution 38, between the healthcare institution 38 and the insurance company 58, between the patient 22 and the doctor 20, etc. These interactions are explained in further detail herein.

For example, as described above, a patient 22 may have his medical history stored in the form of medical records in various source databases as a result of interacting with different medical institutions throughout his lifetime. Thus, the patient may have visited various healthcare providers 36 (doctors, specialists, etc.) and as a result will have medical records stored in various databases 28a. Likewise, the patient may have had procedures done at one or more healthcare institutions 38 (such as a hospital), such that he will have various medical records stored in databases 28b. In addition, the patient may have interacted with certain auxiliary healthcare programs 59 and have other medical records stored in databases 28d. As mentioned above, the present invention does not require central storage of all of these medical history records, but rather allows them to be locally distributed in the various databases described. Paper-based elements can be scanned and stored, and then displayed as an object.

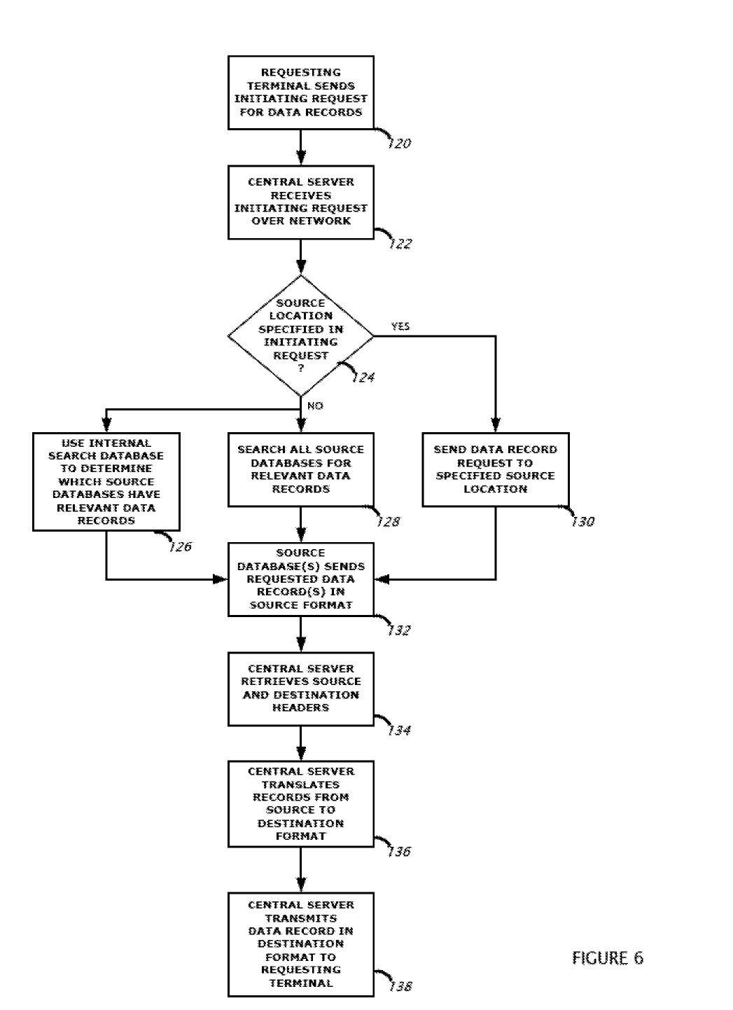

By way of example and with reference to the flowchart of FIG. 6, a patient 22 who is a subscriber to the system will visit a healthcare provider 36 such as a doctor's office and provide pertinent information such as name and/or an identification number and password, and be able to log into the central system 6 to authorize access of his medical records from the various medical record databases 28a, 28b, 28c, 28d, 28f described above. The data requests will be transmitted over the applicable network to the central healthcare management system 6 (steps 120 and 122), which will implement one or more of various search functions to determine the locations of medical records in the various databases 28a, 28b, 28c, 28d, 28f. It is determined at step 124 if the source location is specified in the initiating request. If not specified, then an internal search database may be used to determine which source databases have relevant data records (step 126) (this may encompass a header search as described below), or all source databases may be searched for relevant data records (step 128). If, however, the source location is specified in the initiating request (i.e. the patient is able to specify where the requested data resides), such as by requesting blood test records from the blood labs he visited on a previous occasion (see step 130), then the searches of steps 126 and 128 need not be performed. Once the central system 6 determines the locations of the databases 2828a, 28b, 28c, 28d, 28f that have relevant medical records for this particular patient 22, it will then proceed to retrieve those records in accordance with a data mapping and translation procedure that is further described below. The data mapping and translation is adapted to account for the differences in data formats and layouts amongst the various legacy systems that store the desired medical records in databases 28a, 28b, 28c, 28d, 28f.

The medical records are retrieved from the appropriate databases 28a, 28b, 28c, 28d, 28f (step 132) and then are translated to the format required by the central interpolation server 32 implementing the appropriate data translation headers for the requesting party (steps 134, 136), which in this case is the healthcare provider 36 currently being visited by the patient 22. The central server transmits the data records in the destination format to the requesting terminal (step 138). The medical information may then be stored locally (either temporarily or permanently as desired) and evaluated by the doctor 20, administrator 24, or other healthcare provider as required. New medical information such as diagnoses, medication etc. may then be stored locally in database 28a, and/or it may be uploaded back via the central server 32 for dissemination to appropriate databases 28b, 28c, 28d, 28f in the system.

As a result of this methodology, the healthcare provider 36 will be provided with real-time access to all of the patient's medical records regardless of their location. That is, all records may be retrieved from other healthcare providers 36, healthcare institutions 38, and/or auxiliary healthcare programs 59. This is especially useful for a traveller who becomes ill while away from home. This traveller may visit any healthcare provider 36 or institution 38 that is a subscriber to the system, and thusly enable that party to retrieve current and up-to-date medical records of that patient, and to update those records as well.

The consumer may be given control over his information and be informed of any data requests, and be given the ability to block access by others if desired.

As previously mentioned, the data request sent by the terminal 26 may indicate the specific source database which contains the data records desired, such as a specific hospital where the patient has previously received certain blood tests. In many instances, the source databases will not be known to the requesting party. In this event, several scenarios may occur. First, a search may be made of the various source databases that subscribe to the system. That is, each subscribing source database will be queried by the central server 32 to ascertain if that source database has data relevant to the request—which may be data records for a specific patient, or a group of patients, etc. This would likely require the central server 32 to retrieve the appropriate translation header from database 34 for each source database queried. In this scenario, the source databases would each receive the request and return data for the requesting patient(s) if that database in fact contains the relevant data records. The central server 32 would in turn utilize the translation header for each responding source database in order to translate the returned data into the format required by the requesting party.

In a second search scenario, the central server 32 will operate in conjunction with a search database that will contain information regarding the location of pertinent data for each subscriber in the system. This data may be obtained and/or indexed in a manner similar to an Internet search engine. Once the search database indicates to the central server 32 the locations of source databases having relevant data records, then the central server 32 will query those databases for the required information. The source databases will validate the request to ensure unauthorized access. Although this scenario requires advance programming to enable the search database to collect and index the information, it will be advantageous in providing a faster search with the results returned to the requesting party in a more expedient manner thereby reducing response time. The search database may be located in a secure manner offline and separate from the central server 32 so as to isolate the indexed data content if desired (or it may connect to an external third party search engine).

In a further search scenario, the header library in database 34 may be searched by the central server to determine if the source database associated with a header contains the requested data. This may particularly useful when the requesting party is looking for a certain type of data for all possible patients, without regard to a particular patient. So, for example, if a doctor is performing a study regarding blood tests administered in one county of the state, then the central server can search all of the headers in the library database 34 for all headers indicating blood test results, and can further narrow down the query by geographic location if desired (such as by zip code). The headers of interest will then be used to formulate the appropriate queries as previously described.

As previously mentioned, state healthcare management systems 14 may be part of the system. For example, a state government may employ certain state compliance rules 50 that must be followed by the healthcare provider 36 in order for that healthcare provider 36 to be reimbursed in whole or in part by that state government. As part of the data transactions managed by the central interpolation server 32, the central healthcare management system 6 would access the state compliance rules database 50 for the state where the patient resides. This information is obtained from the patient directly or it is retrieved from a user profile database 44 which will be further described below. For example, a patient 22 who is a subscriber to the system would have a profile record stored in the user profile database 54 at the central system 4, which could contain basic information such as name, address, and insurance carrier and policy number. When the data request is received from the healthcare provider 36 as described above, the central interpolation server 32 can determine the residence of the patient from the central user profile database 54, and then initiate communications with the healthcare management server 42, which will then access state compliance rules database 50 and local compliance rules 52. Those compliance rules may be then accessed by the healthcare provider 36 in administering treatment to the patient 22. A federal rules compliance database 48 may also be accessed in the same manner. Furthermore, the central healthcare management server 32 may access the appropriate payor insurance company computer 58 for that patient. The insurance records database 40 will be accessed and required information would be transmitted, via the central server 32, to the requesting healthcare provider 36.

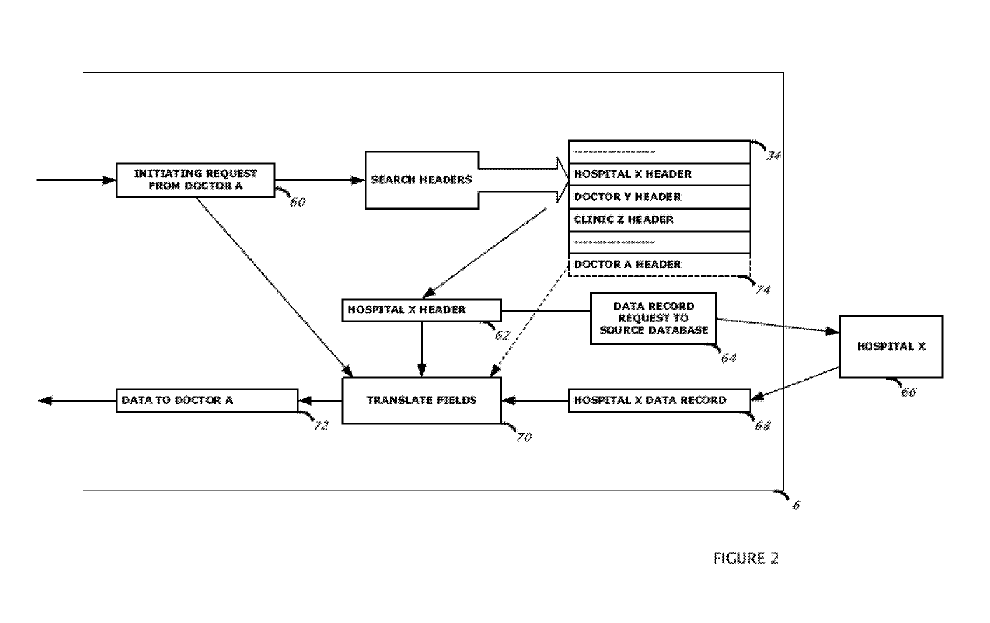

FIG. 2 is a block diagram of the central healthcare management system 6 of FIG. 1A that shows with more specificity the operations of the central interpolation server 32. An initiating request 60 is received from a requesting system access terminal 26 via the applicable network such as the Internet. The initiating request will contain at the very least an identification of a condition that will be used to retrieve relevant data records by the central server. For example, the condition may be an identification of a specific patient for whom data records should be retrieved (e.g. “John Smith”). Alternatively, the condition may be for a certain group of patients such that a data analysis may be made on the relevant data records (e.g. “all patients in the New York City region”). Likewise, the condition specified in the initiating request may be for a specific data record (such as “John Smith's blood test results from May 2007”). Also, the specified condition may be for all data records for the subscriber (such as “all medical records available for John Smith”). Other permutations of these and similar conditions may be used within the spirit and scope of this invention.

The initiating request 60 will also have an identification of the requesting party (such as “Jane Doe's Medical Office”) which will allow the central server 32 to properly translate the retrieved data records into the format required by the requesting party, and optionally allow for a transaction log to be updated for billing and/or record keeping purposes. If no specific format is requested, the server 32 may substitute a standard template or object in order to present the data in a readable format. Thus, the initiating request 60 will identify the type of data required as well as the identification of the requesting party as described above.

The initiating request 60 is sent by the requesting terminal 26 and received by the central system 6. There, the initiating request 60 will be analysed to ascertain the data to be retrieved. For example, if the request 60 specifies the location of the source database to be queried by the central server (e.g. it states to obtain the data from Hospital X), then the server 32 may retrieve a data translation header for Hospital X from translation header database 34. If, however, there is no identification of the specific database to query by the central server, then the central server will do one or more of several types of searches to ascertain the location or locations of the data to be retrieved, as will be described further below.

In the example given where Hospital X is to be queried, then the Hospital X header 62 is retrieved from the database 34 and used to formulate a data record request 64 that is transmitted to Hospital X 66 as the source database. That is, since Hospital X contains the data records of interest it is referred to as the source database. The source database receives the data record request 64, which will be formulated in a manner understandable by Hospital X since the relevant header 62 is being referred to. The legacy or pre-existing computer server at Hospital X 66 (not shown) will receive the data record request, which has been formatted in a custom format specifically for Hospital X using the appropriate header 62, and then retrieve the requested data from its databases. It is noted that security measures will be used such as encryption methodologies to ensure data security and privacy of the patients. Passwords may be required to allow the central server to request and obtain the data records of the subscribing patient.

The requested data is retrieved and transmitted to the central server 32 as a data record 68. The data record 68 will then be translated by translator 70 from the source format provided by the source database at the Hospital X 66 into a destination format that is required by the requesting terminal 26. This re-formatted data record 72 will then be transmitted back to the requesting terminal 26 and displayed there accordingly.

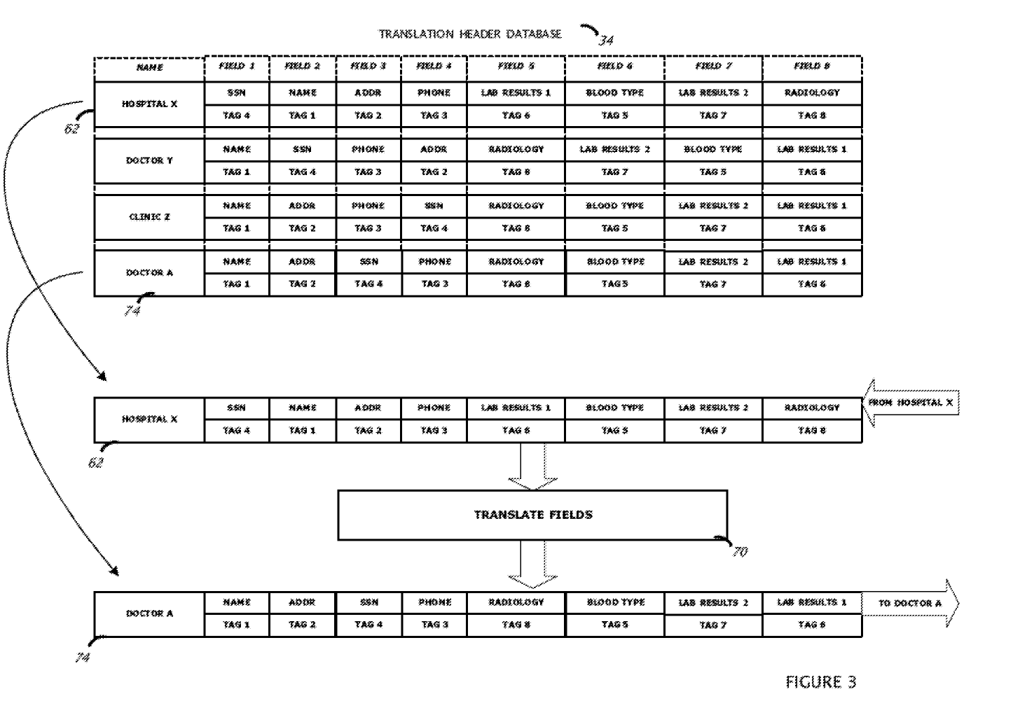

The data translation functionality is shown in further detail in FIG. 3. As shown in FIGS. 1A and 2, the central system 6 has a database library of data translation headers 34. These translation headers will assist or may be used as the key in translating the data from the format of one particular (source) database or server to that of another (destination) as may be required due to differences in data formats of the various legacy systems involved. Each header is derived during a registration process by analyzing a data record of the database with which that header is associated. That is, the system programmer must be aware of the types of data and locations of that data within a data record that is used by a particular database. For example, as shown, in FIG. 3, the data records used by Hospital X has the following format: SSN (Social Security Number); Name, Address, Phone Number, Lab Results 1, Blood Type, Lab Results 2, Radiology Data. Lab Results 1 and 2 may indicate test results from lab tests given to a patient identified in that header, for example. Thus, as seen in FIG. 3, each legacy database may have its own data format that must be implemented in order to retrieve data from that database (source) or send data to that database (destination). It is noted that any unique identifier may be used in the alternative to the social security number.

In order to translate the data from one format to another, each participating subscriber will provide its data formats to the system programmer during the registration process, who will in turn associate each data field with a tag number. A master map will be generated, against which all tag and field assignments will subsequently be made. For example, in this embodiment, the following associations are made:

Tag 1: Name

Tag 2: Address

Tag 3: Phone

Tag 4: SSN

Tag 5: Blood Type

Tag 6: Lab Results 1

Tag 7: Lab Results 2

Tag 8: Radiology

Other tags may of course be generated and assigned as required by the system and formats encountered by the system. Once the master map is generated as above, tags may be associated into a header for a given source or destination based on their formats. The result is a database of headers that are shown by example in FIG. 3. Thus, regardless of the particular field position that a data type may occupy within a data record by any database, the tags or header will indicate what type of data is in that field.

System providers for various third party applications may be accessed by subscribers so they can utilize them on a per transaction basis with payments made to the providers accordingly.

Thus, referring back to the previous example, the header 62 for Hospital X is retrieved from the database 34 since that is the source database designated in the initiating request 60. In addition, the header 74 for Doctor A, as the requesting terminal 26, is retrieved from the database 34. When the data record is received from the source database at Hospital X, then translation logic 70 will analyze the header 62 and the received data record 64 to determine where the data in each field should be placed in the data record 72 to be sent to Doctor A. That is, the data in field 1 of record 64 is indicated by the header 62 to be associated with tag 4 (the SSN), and the header 74 for the destination will dictate that tag 4 data will be inserted into the third field as shown in FIG. 3. Each of the data fields will be analyzed and mapped in accordance with the associated header tags, accordingly.

The map that is generated by translating data from the source format to the destination format via the header tagging system of the present invention may be generated in real time, as was just described, by retrieving the appropriate headers from the library database 34 as they are required. In an alternative embodiment, these maps may be pre-generated and stored for commonly used translations, such as for a frequently requesting hospital obtaining records from a specific source. The pre-generated header maps may then be cached for subsequent use. In the event a certain translation function has not been cached, it would be generated in real time (“on the fly”) as previously described.

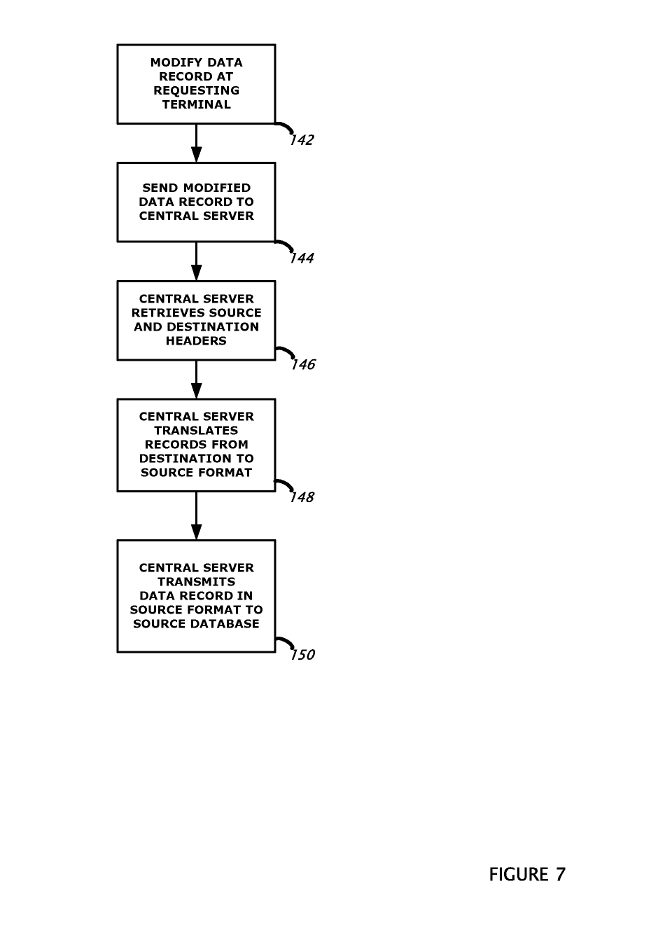

Medical data records may be modified, supplemented, revised, etc. with the present invention, and maintained on the original source database(s). For example, a patient may visit an emergency room and have the results of his previously administered blood tests retrieved from the source database (e.g. a blood lab near his residence) and provided by the central server to the emergency room doctors, and then additional information may be returned back to the original source database via the central server translation process so that the source database is up to date with respect to any new test results from the emergency room visit. Referring to the flowchart of FIG. 7, data is modified at the requesting terminal, e.g. by a doctor or other medical professional (step 142). The modified data record is then sent back to the central server (step 144). The central server retrieves the appropriate source header and destination header as previously described (step 148). The central server will then translate the data records from the destination format (i.e. the requesting party) to the source format (i.e. the source database) (step 148). The central server then transmits the modified data record in the source format to the original source database (step 150).

A person may optionally become a member of the system by subscribing to the services offered to consumers by the central healthcare management server system 6. That is, with respect to consumers, the system is subscription based, wherein a consumer becomes a patient subscriber 22 by paying an enrollment fee and/or periodic membership fee and/or transaction fee to the central healthcare management system 6, which may be operated by an independent management firm, or an insurance company, medical practice, or other entity. The patient will register with the healthcare management system 6 either directly or via a participating healthcare institution (such as a local hospital), or via a participating healthcare provider 36 (such as the family doctor), or via their health insurance company 58. Once registered with the central system 6, it may be preferred for the patient 22 to always use the services of his local healthcare provider 36 but is also able to use the services of other healthcare providers 36.

In addition to individual patients subscribing to the system, families of subscribers are also contemplated to enroll in the system. Data may be collected, stored and analysed for these families (natural, extended or otherwise) to help in providing appropriate diagnosis, treatment, etc. Furthermore, geocentric components of a subscriber may also be logged in order to analyze location-based indicia such as high occurrences of an environmentally effected disease (e.g. breast cancer). Detailed analysis of location based patient data can help to uncover risk factors and develop treatment plans accordingly. Also, these data can lead to intelligent predictive analysis that can be stored in patients' profiles in the user profiles database 54.

The present invention allows integration and analysis of patient data such that candidates for research projects may be selected from the database based on various criteria of the project. For example, a need for sleep-deprived subjects in a medical study may be met be simply querying the various source databases via the central server 32 to find patients with that characteristic.

A healthcare institution 38 such as a hospital may in some situations be the focal point of the value-added or extension services in this invention. For example, a hospital may already be set up to offer standard hospital services, such as emergency room care, surgical services, and general healthcare. Other extension services may be added, such as maternity care, neo-natal care, dentistry, orthodontia, etc. By forming alliances based on the hospital as the core service provider, the system achieves a synergy advantageous to patients as well as the healthcare providers as described herein. Notably, independent healthcare providers may be incentivized to make alliances with a healthcare institution under this system.

Each hospital may provide offers to users to become subscribers to the network by paying an initial subscription fee and filling out various forms that require input of personal information, medical history, insurance information, etc. This information may be input in various electronic forms available via a web server over the Internet, or via a dedicated system access terminal 26 (described further below), or the patient may fill out paper forms and submit them to the hospital, which will enter the data directly or forward the forms to the healthcare service provider for entry. In the alternative, certain information such as existing insurance information may be automatically accessed by communications with the insurance companies 58 or other external databases to provide robust profiles for scoring and risk management. In any event, each patient may have their profile information entered into a central repository 54 at the central healthcare management system 6.

After the patient becomes a subscriber to the system and provides the required information, then the system 2 will issue a membership card or other token to the patient, which may be in the form of any type of card known in the art such as a magnetic stripe card, a card having a bar code or RFID chip, a smart card, a stored value card, etc. The card will have basic information encoded thereon, such as a patient identification number. The identification number may be any indicia that uniquely identifies the patient, such as any arbitrary indicia or even the patient's unique Social Security number, which will allow integration with other databases that utilize the Social Security number. When the patient wishes to use the card, he presents it to a system access terminal at the hospital or other appropriate location, and the appropriate card reading technology will be employed to read the identification number off of the card. A super smart card may be implemented that contains a second processor on the card requiring a higher level of access, thus providing increased security and additional medical information for emergencies (this may also be done on a single processor card having different security levels).

Thus, when a patient 22 requiring medical services presents the card (or other identifier such as a PIN) to a system access terminal 26 at the affiliated healthcare provider 36 or healthcare institution 38, the card will be read (and PIN, or other identification such as a password or biometrics, entered if desired) and the patient identification number will be transmitted, via a network connection such as the Internet, from the system access terminal 26 to the central healthcare management system 6. The central system 6 may, if desired, use the identification number to perform a search to determine the location(s) of the pertinent information for that patient from the various medical record source databases 28a, 28b, 28c, 28d, 28f.

Thus, all of the required insurance information as well as personal information and medical history information is retrieved from the various source databases distributed throughout the system and sent via the translation functionality of the central healthcare management system 6 to the requesting system access terminal 26. There, online forms will be populated with the required data and all of the information will appear in the screen of the system access terminal 26. Rather than having to manually enter each piece of information, the process provides for automatic input from the applicable source database (via the central interpolation server 32), which provides for greater accuracy and increased speed. Records such as X-ray prints and the like may be digitized and stored digitally in any of the distributed medical record source databases 28a, 28b, 28c, 28d, 28f and thus be accessible to any authorized party with a need to access them. A fee may be charged by the central system 4 to the requesting party for transmitting the records; for example, it may cost $20 to provide a set of x-rays that were taken in the past year of a healing bone fracture. Fees will vary based on various factors including but not limited to the size of the file requested, the type of data requested, and the level of accessibility. For example, records stored in archives may take longer to retrieve and thus would be relatively cheaper than records stored in more easily accessible storage. These records would be immediately accessible to any authorized party for the specified fee, which may be charged and paid for by the appropriate payee (e.g. the insurance company). A patient 22 is also able to access his medical information in this manner in a simple and efficient process. The patient 22 may be able to access a web server at the central healthcare management system 6 from any standard web browser running on a patient PC 56, then enter his patient ID number and access his medical history accordingly from the various source databases.

Other benefits are provided to a patient of this system. Since the time and cost otherwise associated with patient screening and intake is reduced substantially, the emergency room personnel can process the patient much faster and are able to provide expedited entry into a screening room, where they will receive the required medical attention. This service may also provide for tiered services, wherein certain patients (e.g. those paying a higher premium or in a more fragile condition) will receive care prior to others, as long as the other patient is not in a life-threatening situation. This provides an incentive for patients to subscribe to the system since they will move to the head of the line faster than those who are not subscribers. This is akin to use of an express lane on a highway system. This benefits hospitals since they can process these patients faster due to the automated data retrieval and form population.

By issuing priority healthcare cards as described herein, the hospital may be co-branded with the central service provider. Thus, a patient may have a “St. Luke's Hospital PRIORITY CARE Card” or the like, designating their primary hospital for healthcare services. This will immediately identify the patient as belonging to that primary hospitals' service upon entry to the emergency room. Different member hospitals would enter into agreements with each other and/or the central service provider to allow patients to use other hospitals (secondary hospitals) if necessary (e.g. while travelling), and the same information would be retrieved for that secondary hospital since they utilize the same system, forms, etc. Rules may be established wherein subscribers at secondary hospitals are given priority treatment over non-subscribers, but not over those subscribers at that hospital.

Revenue may be generated on a subscription basis, wherein a subscriber pays a periodic or one-time fee for being a member of the system. For example, a patient may pay a $20 yearly fee, or a doctor may pay a $500 one-time fee, etc. Likewise, transaction fees may be imposed by the healthcare management service, state, or other entity as authorized, which may or may not be paid by the insurer.

Separate legacy servers that currently exist to provide compliance rules and regulations (federal rules 48, state rules 50, local rules 52) may be accessed via the data translation technology of the interpolation server 32 of this system. The compliance rules are related to interactions between the multiple entities associated with the system, i.e. the patients, insurers, and healthcare providers and institutions. The compliance rules may be based on information, rules and regulations promulgated by one or more various institutions, such as a healthcare insurance company, a governmental entity, doctor's office or patient, etc. The compliance rules may set forth predetermined standards of care, such as standards of care for a pregnant woman (e.g. how many physician visits are appropriate, and at which intervals, which test should be administered and when, etc.). The compliance rules may also set forth standards of payment promulgated by an insurance company, such as which treatments are covered for particular ailments, etc. The compliance rules may encompass any predetermined standard, rule or regulation as may be applicable in the healthcare industry.

The monitoring service of the present invention will utilize some or all of the predetermined compliance rules in order to evaluate a proposed course of treatment or the like. Thus, when a patient presents his identification card to a healthcare provider such as a doctor 20, the card will be swiped into a system access terminal 26 located in the doctor's office. The patient's identification indicia will be read off of the card and a request will be formulated with the following information:
the patient identification indicia as read off of the healthcare card (or other like token)
a description or other identification (e.g. code) of the healthcare services that are being proposed to be administered by the healthcare provider or which have already been administered (such as a sonogram for a pregnant woman)
an identification of the healthcare provider (e.g. the doctor's subscriber/ID number)
   Optionally, other information may include the healthcare institution that may be involved (e.g. the name of a clinic or hospital), and other pertinent information regarding the condition of the patient. The request will thus at least have information that indicates who is about to administer a procedure, what the procedure is, and on whom the procedure will be administered (e.g. Dr. John Smith will perform a sonogram on Mrs. Mary Doe, who is in her fifth month of pregnancy).

The request will then be transmitted by the system access terminal 26 to the central healthcare management system 6 over the computer network (i.e. the Internet). The central healthcare management system 6 will receive the request and then access external source databases by using the request information. The central interpolation server 32 will in particular access the compliance rules databases 48, 50, 52 as mentioned above to determine if the proposed course of treatment is acceptable under the circumstances. If the proposed treatment is in fact in compliance with the predetermined standards, then this will generate an approval message which will be transmitted back via the interpolation server 32 to the system access terminal 26 and also stored in transaction log 46 for future reference. The healthcare provider will be informed that the proposed procedure has been approved and may then proceed as planned.

The insurance company 58 may also be included in this process to ensure that payment may be made on a timely basis by the insurance company to the healthcare provider. Once the process has been approved, then there is an assurance to the healthcare provider that correct payment will be made. The process may be completed when the healthcare provider indicates that the procedure has been administered, which may be confirmed by the patient as well via entries on a system access terminal 26. In addition, the patient may be asked to approve payment or may be asked to respond to an exit survey regarding the services rendered.

Referring back to FIG. 1, the state-based central healthcare system 6 of the present invention is adapted to interact not only with requesting entities 18, source database locations 16 and existing state healthcare management system(s) 14, but also with state-based central healthcare systems 6 operating in other states via wide area network 8 such as the Internet. That is, each state's central system 6 can look to resources outside the state, such as source databases at hospitals etc outside the state, in order to obtain the requested medical records in a cross-border transaction. Each state's central system 6 will interact with each other based on the data request. Thus, if the data request by an entity in State A requests records from a hospital located in State B, then the central server 32 in State A will query the central server 32 in State B for the requested record, and the server 32 n State B will retrieve the desired records in the same manner as if the request originated from an entity in State B. The records are retrieved and then transmitted to the server 32 in State A for transmittal back to the requesting party. Data may be exchanged between servers 32 in various states in a predetermined format, in the source format, or in the destination format, as may be desired.

In the event that a requesting entity requires a search to be done, then as part of the search, the central server 32 may include sources directly accessible by the server 32 in the other state(s). That is, if the server 32 in State A queries all source databases in State A for medical records of John Smith, it may also request the server 32 in State B to do the same. This may of course be extended to as many states as desired, or the search engine may interrogate the entire system. The search results from each state would then be returned to the originating server 32, translated as required, and transmitted to the requesting party.

The enterprise server 10 is now described with reference to FIG. 1. The enterprise server is implemented to manage data retrieval and translation between entities in states that do not subscribe to the system and those who do (i.e. affiliated and unaffiliated entities). This allows entities from unaffiliated states to register with the enterprise server so the appropriate central server may route data record requests to these unaffiliated entities without requiring them to be affiliated with a state-based central server system. For example, a patient may reside in a state that does not have a state-based central healthcare system 6 implemented that can interoperate with other such systems. The enterprise server 10 would query the relevant state systems, as described above with respect to cross-border transactions, and return the retrieved records accordingly. Likewise, the enterprise server may manage transactions with source databases in states that are not yet affiliated with a system in that state. So, when a data request is made to one of the servers 32 in a participating state, the server 32 may query the enterprise server 10 in the same manner as described above with respect to cross-border transactions, and any unaffiliated healthcare entities that interact with the enterprise server 10 can provide data records to the requesting party.

In another aspect of this invention, a dynamic health score program may be established, which can optionally be integrated with the healthcare card. A schedule will be generated at the central server or other entity in the system that sets forth certain health related tasks or criteria, such as a yearly dental check-up, and an associated number of health points that would be awarded to a patient who completes that task to generate a health score. These tasks would promote well-being, including but not limited to dental check-ups, prostate examinations, breast examinations, vitamin purchases, cholesterol review, etc. The tasks would be based on a profile of requirements of the insurer or other participating entity. By awarding these health performance points to generate a dynamic health score, and (optionally) tracking them via the healthcare card, the patient is incentivized to perform these tasks since they can be used to earn broader insurance benefits, discounts, or to reduce costs. In addition to the tasks mentioned above, health performance points may be awarded to individuals based on actual performance data. Thus, points may be awarded as a function of the patient's weight, in which patients at a goal weight would receive more points than someone who is overweight. Likewise, non-smokers would get points whereas smokers would receive no points or even have points deducted. Health points would be tracked in one or more of the various health point score databases 30a, 30b, 30c, 30d, 30e and/or 30f as shown in FIG. 1A. Negative points may be assessed if healthy practices are not adhered to, resulting in a net deduction from the health point account and a lowering of the dynamic health score. For example, if a patient is unable to quit smoking or is significantly overweight or misses a doctor's appointment, he may have points deducted from his account and his dynamic health score lowered.

As mentioned, a patient that has reached a predetermined milestone of accumulated health performance points may receive favorable rates on health insurance premiums, since healthier patients (as measured by their relatively higher health score) generally translate to lower insurance costs. Likewise, doctors and other healthcare providers may have their patients' health points tracked so as to determine those doctors with healthier patients, at least as determined by their health score. Doctors with larger numbers of patients having higher health scores will be rewarded with health performance points of their own based on their patients' performances, and then by being provided with lower malpractice insurance costs based on a premise that a healthier patient will be less likely to require medical attention and thus less likely to be subject to medical procedures that are accompanied by risk of malpractice. This premise may be extended to hospitals and other entities that have doctors with relatively higher health scores (based in whole or in part on their patients' health scores), which will then also receive lower insurance rates. The converse may also be implemented, where lower health point scores will yield higher insurance rates.

Health scores are tracked in one or more health score accounts as shown in FIG. 1A. A health score account may be stored locally at a healthcare provider health point database 30a, a healthcare institution health point database 30b, an insurance company health point database 30e, or an auxiliary healthcare program database 30d. In addition, health scores may be tracked in central system database 30c or state management system database 30f. Health points may be added to the score (or deducted from the score) as described above.

Thus, this dynamic health performance score system will provide a mechanism for risk management, by allocating lower costs of participation to those who can objectively demonstrate their lower risk factors or higher performance via accumulation of health performance points and a higher health score.

An authorized subscriber such as a patient 22, doctor 20 or administrator 24, may be given access to various data over the network by interconnecting with the central interpolation server 32 as described above. In addition, the subscriber may be given a menu of plan options from the central server 32 that may be reviewed and selected as desired. For example, a multi-tiered set of services may be offered (e.g. silver, gold, platinum), and the patient may choose or modify the desired plan. Payment may easily be made by any means known in the art, including but not limited to credit card, smart card, debit card, stored value card, or check.

The patient may also be able to access various records via his priority care card, such as insurance records 40, and if allowed he may modify those records online. For example, by using his card to access his insurance information from the insurance database 40 at the appropriate insurance company 58, the patient may be able to increase the amount of insurance he has (health, but also possibly automobile, life, property, etc.) in a given situation. A waiting period may be established before the modified insurance would be accepted, for instance to verify any changes in conditions of the insured party.

The present invention operates over a network (or set of independent networks) that interconnects the various parties mentioned herein. In one embodiment, the approval and payment processes operate over a separate network that may piggyback the existing credit card infrastructure and operate in a similar manner, wherein parties request and obtain approval for health transactions in the same manner that banks interoperate over the credit card network. A separate information network, such as the Internet, could also be utilized to interconnect the various entities to provide information flows therebetween, such as when a patient logs onto the system to access his medical records. In another embodiment, a single network such as the Internet may be used to accomplish all functionality if desired.

The patient's profile, which may be stored at user profile database 44 in the applicable state system 16 or if desired in a user profile database 54 of the central healthcare management system 6, may have various levels of access proscribed in order to provide desired levels of privacy to the patient. For example, there may be three levels of access defined; highly confidential, moderately confidential, and non-confidential. The fact that a patient may have a disease such as AIDS may be classified as highly confidential, but his blood type may only be classified as non-confidential, etc. Then, in a given situation, rules would be defined that would allow certain persons access to only the non-confidential information, for example, and not the highly confidential information. Each healthcare provider or authorized person would have a security level assigned to them, and they would be required to enter their ID code at the time information is requested. The patient profile and rules would determine which information that person should have access to, and transmit only that information accordingly. These rules may be modified in emergency situations, which are also defined by predetermined rules.

The subscriber may also enter the names and contact information for emergency contact persons, such as a spouse, parent, or child. When a patient presents his card to the emergency room at a hospital, the emergency contact information will be retrieved from the user profile database 54 or 44 and the hospital may use this information to manually or automatically contact the designated person. For example, a patient may specify that in the event of an emergency room visit, certain people (such as his spouse and parents) must be notified, and their contact information is provided. The specific persons contacted may depend on the level of the emergency, e.g. his parents are only notified in an extreme emergency, or if his spouse cannot be reached. The central service or a third party may be utilized to perform these services as well. Other events may be triggered as well. For example, in the event that a person is admitted to a hospital, the patient's profile may indicate that the local post office should be contacted to halt mail delivery, the news carrier should likewise be contacted to halt newspaper delivery, etc. This is particularly useful for those living alone, such as the elderly, who would not have someone at home that could take care of these events. Value-added services could also be instituted and triggered by events as indicated in a patient's profile. A further example would be a service that provides meals to the elderly or infirm.

By utilizing the present invention, payments may be made in an expedited fashion to the healthcare providers 36 and healthcare institutions 38. The central healthcare management system 6 may assist the insurance company 58 to provide quick payment to the recipients in exchange for an agreed-to discount, which may be on a sliding scale. For example, next day payment may be provided in the amount of 92% of the fees, with the remaining 8% being retained as a transaction fee. That is, on a $1,000 bill that would be covered by insurance, the management service would pay the recipient $920 the day after the service is rendered. The management company or payor would be assigned to the right to collect the full payment from the insurance company ($1,000) and would retain the $80 difference as a transaction fee. Payment may not be made by the insurance company for a prolonged period of time, but this is what the transaction fee is intended to account for. The percentage may change as a function of delay in payment, so for example if the recipient is willing to receive payment from the management service one week later rather than one day later, they may get 94%, or if they take payment one month later they may receive 96%, etc. Other alternatives may be used, such as providing certain discounts based on volume, or on a sliding time scale, etc. These terms of payment would be agreed to by the parties contractually. The healthcare providers may indicate in a profile, for example at registration, their preferred form of payment, which may be modified as specified by the system.

This invention solves various problems for all of the parties that interact in the current medical care environment. Doctors and other healthcare providers will benefit by obtaining payment for their services in a timely manner, and by having reduced paperwork and operating costs. Patients will no longer suffer from lack of information about their past and current medical conditions as well as future requirements, and the lack of timely, attentive services in this area. Insurers will be able to obtain better records, patient and doctor information, and accounting records, and will be able to enforce rules and manage providers and patients better in order to reduce risks and their attendant costs.

System access terminals 26 may be strategically located at various physical locations at a given healthcare institutions 38 or premises of healthcare providers 36. The patient may be required to swipe his priority care card upon entering an examination room, for example, in a doctor's office. The doctor may also be required to enter his ID code into the system access terminal 26 upon starting and ending the treatment. Thus, a record is kept in transaction log database 46 at the state management system of when the patient received his treatment. This information may be used to combat fraudulent claims, for example if a healthcare provider makes a fraudulent claim that a patient visited his office for treatment on a day when there is no log of such visit according to the terminal data. Furthermore, once the patient swipes his card into the terminal 26, his medical records may be retrieved from various source databases via the interpolation server 32 as previously described. This would expedite treatment since, by the time the doctor actually enters the examination room to make an analysis and dispense treatment, the medical records would be displayed on a screen of a networked computer. The doctor would use that information during his analysis, and then may be able to enter modified data to update the medical records in accordance with the treatment being given at that time.

Any type of device that will enable a user to interconnect to the system, enter data and receive information back from the healthcare management server may be used in addition to computers as shown in the Figures. Thus, handheld wireless devices such as cell phones, PDAs, etc. are envisioned to be interoperable with the system of the present invention.

In a further embodiment, the doctor may make a drug prescription while the patient is being treated and enter it into his computer, which would be uploaded into the patient's file at the applicable database 28a, 28b, 28c, 28d, 28f. This prescription may then be automatically downloaded to a pharmacy previously designated by the patient, where the pharmacist would be able to prepare the medication for pickup by the patient upon presentment of the priority care card. In the alternative, the prescription would be held temporarily at the central interpolation server 32, and then when the patient arrives at any participating pharmacy and presents his priority care card, the prescription would be retrieved and fulfilled. This also provides for the ability to keep track of the usage of pharmaceuticals and other medical supplies, and enable an automatic or semi-automatic ordering system whereby supplies that are tracked via the system as being in low supply are ordered and restocked accordingly.

The present invention provides for marketing of products and services by participants. For example, a healthcare provider that administers prenatal care to a patient would be able to market appropriate products to that patient either at the time of treatment or before or afterwards.

In addition to the parties mentioned herein, other third party providers that are not subscribers to the system may subscribe or may be enabled to plug-in and interoperate with the system as long as certain security constraints are adhered to. Payment mechanisms would be employed to ensure that such non-registered third party participants make appropriate financial payments in exchange for interoperating with the system.

As previously mentioned, the priority care card may be in the form of a magnetic stripe or bar coded card, in which case the information embedded in the card would be minimal—likely only an identification number and/or name—and the patient's information, medical records, profiles, etc., would all be stored as described herein. In an alternative embodiment, a smart card or stored value card may be used, which advantageously carries memory and/or processing circuitry as known in the art. In this case, much more information may be carried by the card for local applications where the central server and/or local databases 28a, 28b, 28c, 28d, 28f are not easily accessed. Furthermore, the data stored on the card may be modified by the local access terminal in accordance with the application parameters. For example, it would be possible to store various health scores, previously mentioned, in memory on the card rather than at the various databases 30. Thus, in the event that the card is used with applications that are not interoperable with the system, but which accept health points as a universal currency, then the off-network application could use the health points as currency for making purchases or achieving better benefits as well as results. That is, the local application could access the health score account, make appropriate deductions (or additions), without having to contact the central server 32.

Another feature of the present invention provides for a medical audit process for patients. Each patient may have their own personal web page stored at or accessible via the healthcare management system 6, which may be loaded into any web browser on a patient PC 56 after an initial log-in process. There, the patient may view all of his medical and insurance information obtained from any of the source databases for which he is authorized, including but not limited to prior medical events (such as checkups, treatments, diagnoses, drug prescriptions, test results), insurance information (such as policies, claims made and status thereof, contact information), medication information such as expiration dates, etc. These records are obtained and translated via the central interpolation server 32 as described above. There will also be a timetable or schedule (a “medical calendar”) of recommended treatments that sets forth the various procedures recommended for that patient, such as prostate screening at age 45, etc. This may be generated in conjunction with the compliance rules in the databases 48, 50, 52. This will greatly enhance the patient's ability to manage his medical and insurance information via the central server 32. The patient will also be able to make or view changes in his policy coverage by interacting with the central server, which in turn will interact with the interconnected insurance companies as requested.

The present invention provides for a web site to be established at the central healthcare management system 6 that will enable a patient to view provider listings and obtain information regarding the various healthcare providers and institutions that are part of the system. The central management system can present information such as referrals, ratings, recommendations, qualifications, and the like, which will enable the patient to make informed decisions regarding their choice of healthcare provider based on this information. Thus, a patient may be able to determine that a certain doctor is highly recommended for certain procedures but not for others. This also enables cost comparisons, which may be especially useful if the patient must pay for an appreciable part of the treatment (such as with deductibles, co-payments, etc).

The healthcare card of the present invention and system with which it operates contemplates the integration with auxiliary healthcare programs 59 including biological depositories such as blood banks, tissue banks, etc. The system may integrate with these entities so that a patient may for example make a blood donation and simply present his card to a system access terminal 26 at the time of the blood donation. By identifying the person via the card, the auxiliary healthcare program can look up the relevant data from the various databases via the central healthcare management system 6 such as name, blood type, and disease history. As long as that person shows no diseases on file that would deter the blood bank from accepting his blood as a donation, then the blood extraction proceeds. If however that person's medical history reveals a disease such as AIDS, then the program will be alerted to that fact and the blood will not be accepted.

When a person makes a blood donation under this embodiment, the donation will be noted on his account. Health points may be awarded and added to the patient's dynamic health score for the blood donation. The blood itself that is donated may also be tracked to that person via his identification card. The information may be stored in any of the appropriate databases via the central server and accessed via identification of the card presented, or the data may be stored on the card itself and updated accordingly, such as with a stored value card, a smart card and the like.

A further embodiment of the system provides for an implantable token such as a subdermal implant that is encoded with information that links to the system in the same manner as the healthcare card previously described. By using an appropriate reader, the healthcare provider may quickly ascertain the medical history, records etc. of the carrier without requiring them to physically present the card. This is quite useful in emergency situations, such as in a battlefield, where the wounded patient is unable to speak with the doctor or present his card. In the event that the patient has no wallet or other means of carrying a card, the subdermal implant will link the doctors to the same information stored in the system.

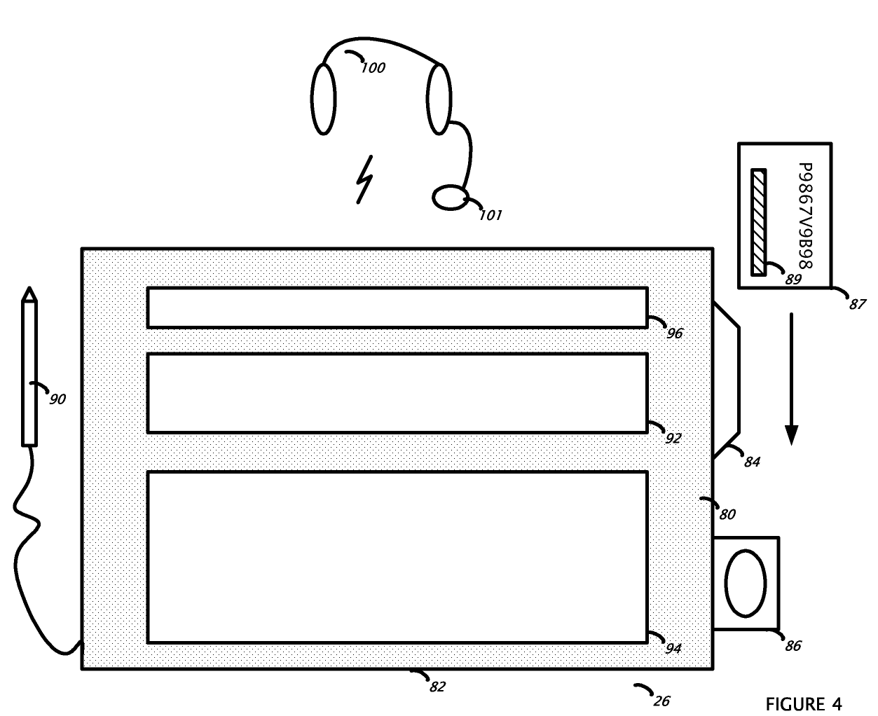

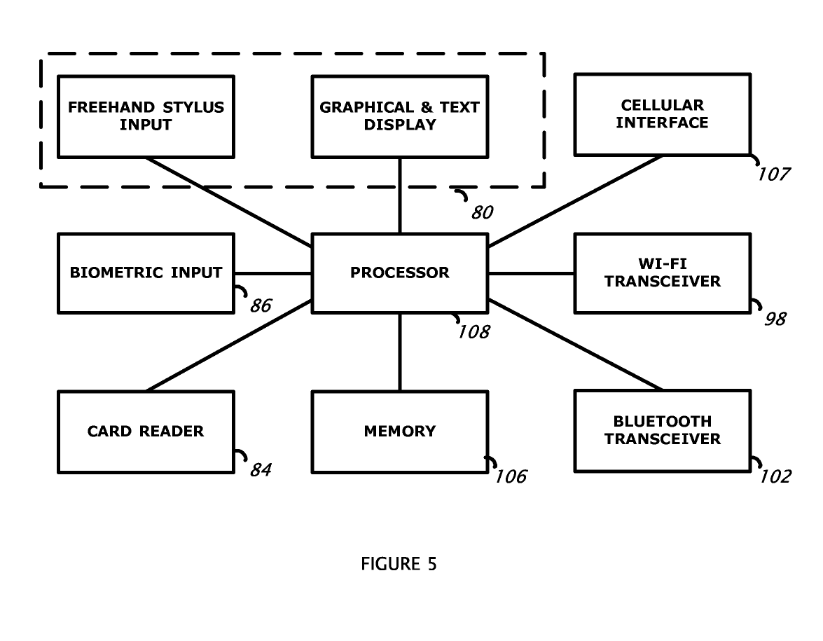

A portable computing terminal useful as the system access terminal 26 implemented with the present invention is now described in further detail. FIG. 4 is an illustration of a system access terminal 26, and FIG. 5 is a block diagram of the functionality and circuitry of the terminal 26. The terminal 26 may be a lightweight, battery powered portable device that includes a touchscreen display 80 in a housing 82. Also provided on the housing 82 will be one or more of several types of user identification and authentication devices, such as a card reader 84 and/or a thumbprint reader 86. Optionally, a stylus 90 may be tethered to the housing 82, which will be useful in providing user input to the touchscreen 80 as known in the art. Instead of or in addition to a stylus, the touchscreen may accept user input from a fingertip of the user.

The touchscreen 80 is adapted to display output in the form of text 92 and/or graphical elements 94 as known in the art. Likewise, the touchscreen will provide user input forms 96 that will allow entry by the user of information prompted by the display 80, such as name, password, etc., as may be required by the application being implemented. As known in the art, handwriting recognition programs may be implemented in order to allow a user to provide freeform entry that may be recognized by the terminal, similar to GRAFFITI software that is used for example on a PALM PDA device. A pop-up keyboard that displays letters, numbers and punctuation marks may also be implemented whereby the user may select, with a stylus or fingertip, the desired characters from the pop-up keyboard for the desired entry of information into the form 96. Additional entry elements such as radio buttons, check boxes, scroll lists, etc., as well known in the art, may also be used if desired.

The card reader 84 is adapted to allow a user to swipe his identification card 87 (as described above) so that the magnetic stripe may be read and processed. The data encoded in the magnetic stripe 89 will allow quick and accurate identification of the user. Of course, password authentication may also be used, wherein the user would be prompted to enter his or her password onto the touchscreen after the card has been swiped to ensure the authenticity of the user. Alternative identification and/or authentication mechanisms may be employed, such as by using the thumbprint reader 86.

The information obtained from the user, which includes the user's identification (e.g. from the card reader 84) and the password (obtained from the touchscreen) or the thumbprint reader 86, will be transmitted via a wireless link (WI-FI RF transceiver 98) to a local network access point or other terminal in the location where the portable terminal is being used. Different types of computer and network architecture may be utilized as known in the art. For example, a hospital may implement a secure WI-FI network configuration with wireless access points distributed throughout the hospital building so that anyone in range of the wireless network may communicate with the network using the portable terminal 26. Standard or proprietary protocols such as encryption may be used to ensure data security, as well known in the art. By interconnecting the portable terminal 26 with the local network, it may then exchange data with computers in the system as has been described herein.

A wireless headset device such as bluetooth headset 100 may be used in conjunction with an accompanying bluetooth transceiver 102 located in the housing 82. The headset 100 enables a user within short range of the terminal 26 to listen to audio output by the terminal 26 as well as provide voice input into the terminal 26. Other wireless technologies in addition to bluetooth may also be used (as well as a wired connection between the headset 100 and the terminal 26). Voice input may be used to capture the user's voice (which may also be used for authentication purposes), and to enable voice-to-text conversion by processor 108. Thus, a patient using the terminal 26 in a hospital may be prompted by the terminal 26 to describe his or her symptoms, which may be spoken by the patient via a microphone 101 so that the spoken description of the symptoms may be easily captured and converted to textual input by voice-to-text software executing on the processor 108, captured as an audio file (e.g. WAV or MP3) and stored in memory 106, or both. By capturing the patient's description of his symptoms, for example, a historical record may be captured and archived for subsequent use. Also, the patient could record a spoken description of his symptoms for subsequent review by a doctor, etc.

The headset 100 also enables audio prompts etc. to be played to the user, which can be of great use in situations where the user is unable to read prompts and data on the touchscreen 80 (e.g. an illiterate patient, or one with limited eyesight, etc). These audio prompts may be synthesized as known in the art by processing means 108, which could take textual input and synthesize vocal outputs.

Use of the headset also enables real-time communications between one user and another user that is using a similar terminal on the system (e.g. a patient in one location of a hospital and a doctor in another location of the hospital), or it may be used to access a cellular telephone network via cellular interface 107, etc. Thus, a doctor who is using the terminal 76 to access medical records of a patient may call another doctor who is familiar with the patient and his records for real-time consultation regarding the records. For example, a specialist at a hospital who is reviewing an x-ray of a patient via the touchscreen may speak to the technician who generated the x-rays for discussion of the methodology used, etc. A prompt may be generated by the terminal and displayed on the touchscreen such that by selecting the prompt (button) on the touchscreen, a cellular telephone call is automatically placed to the technician and the doctor may speak with the technician via the headset 100 and microphone 101.

An example of a patient using this terminal 26 is now provided. The patient enters a waiting room in the office of a medical specialist and is given a terminal 26. The patient swipes his healthcare card into the magnetic stripe reader 84, and the patient identification information is read off of the card. A form is displayed on the touchscreen 80 that asks the patient to enter his password on a pop-up keyboard, The patient enters the password into the entry field of the form, and the patient identification information and password information is sent in a secure manner via the RF transceiver 98 onto a local area network (LAN) in the specialist doctor's office. That information is then processed by a server computer on the LAN and transmitted in a secure manner (e.g. encryption) to the healthcare management system 6. There, the patient information is authenticated and a validation message is returned to the local server at the specialist's office. Source databases are accessed for pertinent data as previously described, translated into the appropriate format as previously described, and sent back to the terminal 26 along with additional information including but not limited to the patient's name, address, contact information, insurance information, medical history, etc. This information may then be populated into the local server and/or the portable terminal 26 at the specialist's office for subsequent review by the specialist doctor.

Included in the medical information in this example is a digital x-ray file that has an x-ray of the patient's recently broken arm that was taken at the emergency room at a hospital. The patient has previously undergone a similar process when he visited the emergency room where the x-ray was taken and a cast was placed on the break. When the specialist doctor is ready to see the patient, he may take the terminal 26 from the patient (or use a different terminal as he may desire) and then log into the system by swiping his card and providing a password as described above. This ensures that only an authorized user will have access to the medical records as previously described. The specialist may then view the x-ray on the touchscreen display, as well as all other medical history retrieved via the healthcare management server 32. The specialist may modify the medical information, such as by adding a record of the current office visit by the patient, describing the progress of the healing of the broken bone, etc. This may be entered via textual input on a pop-up keyboard form, or by a spoken voice entry via the headset as previously described.

The specialist doctor may also place a telephone call via the headset or the device to the doctor who set the cast, the technician who took the x-ray, the insurance company, etc. All of the contact information, including the name and telephone number, would be included in the medical history retrieved via the healthcare management server 32. An option to simply select a call button would allow a cell telephone call to be placed via the cellular interface to the desired party for further consultation.

Once the specialist doctor has finished the consultation and optionally revised the medical records via the terminal 26, then the patient will be given the terminal again for a checkout process. This may be done in conjunction with a receptionist at the office on the way out. The insurance information may indicate a co-pay of $20, which will be tendered to the receptionist. The patient will acknowledge treatment by the specialist on the terminal, which information will be transmitted back to the server 32. This will enable the specialist doctor to be paid for the office visit by the insurance company.

I claim:

1. A method of operating a centralized healthcare management system comprising:
receiving, via a network, an initiating request from a requesting terminal for a data record to be retrieved that satisfies a specified condition;
sending, via the network, a data record request to a source database;
receiving, via the network, a data record from the source database, said data record being in a source format;
a central interpolation server referencing a data translation map database for a desired translation map, said data translation map enabling said central interpolation server to translate data records from a source format to a destination format;
the central interpolation server translating, in accordance with the selected data translation map, the received data record from the source format into a destination format suitable for transmission to the requesting terminal, and
transmitting the data records in the destination format to the requesting terminal via the network.

2. The method of claim 1 in which the initiating request comprises an identification of the source database to which to send the data record request.

3. The method of claim 1 in which the data record request is sent to a plurality of source databases interconnected to the centralized healthcare management system via the network, each of which may or may not comprise data records that satisfy the specified condition.

4. The method of claim 1 further comprising the central interpolation server executing a search to determine an identification of at least one source database comprising a data record that satisfies the specified condition.

5. The method of claim 4 in which the data record request is sent to at least one source database determined by the search.

6. The method of claim 5 in which the search is performed against a search database previously compiled by the central interpolation server.

7. The method of claim 6 in which the search database previously compiled by the central interpolation server is the data translation map database.

8. The method of claim 1 in which the specified condition of the data request comprises an identification of a specific data record requested for a specific subscriber.

9. The method of claim 1 in which the specified condition of the data request comprises a request for all data records available for a specific subscriber.

10. The method of claim 1 in which the specified condition of the data request comprises an identification of a specific data record requested for a group of subscribers meeting a predefined criteria.

11. The method of claim 1 in which the specified condition of the data request comprises an identification of all data records available for a group of subscribers meeting a predefined criteria.

12. The method of claim 1 wherein said data translation map database comprises a plurality of headers, each header associated with a source database or a destination database, each header comprising a plurality of different fields and a plurality of associated tags, wherein each tag is assigned to a field, and wherein tags from a header associated with a first database may be mapped with tags from a header associated with a second database such that a field in a data record from the first database may be matched to a field in a data record from the second database in accordance with the matching of the respective tags, regardless of the location of each field in the respective data record.

13. The method of claim 12 wherein said translation map is generated in real-time by retrieving a header associated with the source database and a header associated with the requesting terminal.

14. The method of claim 1 further comprising the step of modifying data in the source database by:
receiving, at the central interpolation server, a modified data record from the requesting terminal, the modified data record being in the destination format;
the central interpolation server translating, in accordance with the data translation map, the received modified data record from the destination format into the source format; and
transmitting the modified data record in the source format to the source database via the network.

15. The method of claim 1 in which no data records are maintained at the centralized healthcare management system whereby all data record requests are made to external source databases.

16. The method of claim 1 further comprising storing at the centralized healthcare management system a plurality of data records of subscribers electing to use the centralized healthcare management system as a central repository of data records for subsequent use.

17. A centralized healthcare management system comprising:
a central interpolation server computer interconnected to a computer network, the central healthcare management server computer adapted to:
receive, via a network, an initiating request from a requesting terminal for a data record to be retrieved that satisfies a specified condition;
send, via the network, a data record request to a source database;
receive, via the network, a data record from the source database, said data record being in a source format;
reference a data translation map database for a desired translation map;
translate, in accordance with the selected data translation map, the received data record from the source format into a destination format suitable for transmission to the requesting terminal, and
transmit the data records in the destination format to the requesting terminal via the network; and
a data translation map database comprising map data enabling said central interpolation server to translate data records from a source format to a destination format.

18. The system of claim 17 in which the central interpolation server is further adapted to execute a search to determine an identification of at least one source database comprising a data record that satisfies the specified condition.

19. The system of claim 18 in which the search is performed against a search database previously compiled by the central interpolation server.

20. The system of claim 17 wherein said data translation map database comprises a plurality of headers, each header associated with a source database or a destination database, each header comprising a plurality of different fields and a plurality of associated tags, wherein each tag is assigned to a field, and wherein tags from a header associated with a first database may be mapped with tags from a header associated with a second database such that a field in a data record from the first database may be matched to a field in a data record from the second database in accordance with the matching of the respective tags, regardless of the location of each field in the respective data record.
